(19) United States
(12) Patent Application Publication
(10) Pub. No.: US 2025/0373665 A1
(43) Pub. Date: Dec. 4, 2025

(54) EXPLORING SECURITY RULE CHAINS IN A SECURITY PLATFORM

(71) Applicant: Google LLC, Mountain View, CA (US)

(72) Inventors: Michael Hom, Arlington, VA (US); Nicole Anderson-Au, Cupertino, CA (US); Benjamin Chang, Sunnyvale, CA (US); Jason Wong, Santa Clara, CA (US); Winnie Chai, Los Altos, CA (US); Sarmad Qutub, Orland Park, IL (US); Andrew Fax Rector, San Francisco, CA (US); Vlad Grigorescu, Champaign, IL (US); Borja Zarco, Fort Lee, NJ (US)

(21) Appl. No.: 19/219,657

(22) Filed: May 27, 2025

Related U.S. Application Data
(60) Provisional application No. 63/654,935, filed on Jun. 1, 2024.

(51) Int. Cl. H04L 9/40; H04L 41/22

(52) U.S. Cl. CPC H04L 63/20; H04L 41/22

(57) ABSTRACT

A system and method for exploring security rule chains in a security platform. The method includes displaying a first plurality of graphical elements of a graphical user interface (GUI), each graphical element of the first plurality of graphical elements referencing a respective chained outcome of a plurality of chained outcomes of a respective chained rule, The respective chained rule includes two or more security rules that are linked based on their respective security outcomes, receiving, via the GUI, a selection of a first graphical element of the first plurality of graphical elements, the first graphical element corresponding to a first chained outcome of the plurality of chained outcomes, and displaying a second plurality of graphical elements in a visual association with the first element, each element of the second plurality of elements referencing a respective security outcome of the two or more security rules that are serially linked.

### CLAIM OF PRIORITY

The present application claims the benefit under 35 U.S.C. § 119(e) of U.S. Provisional Patent Application No. 63/654,935 filed Jun. 1, 2024, which is incorporated by reference herein.

### TECHNICAL FIELD

The present disclosure relates generally to cloud-based cybersecurity platforms. In particular, aspects and implementations of the present disclosure relate to exploring security rule chains in a security platform.

### BACKGROUND

In today's digital age, organizations are constantly facing an increasing volume of sophisticated cybersecurity threats. Cybersecurity is the practice of protecting systems, networks, and data from digital attacks, unauthorized access, and damage. Traditional cybersecurity measures are often inadequate in providing comprehensive protection against such threats, which has resulted in the proliferation of large numbers of disparate cybersecurity operations tools such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. These platforms and system can generate multiple alerts for each detection of a security threat. Because not all security threats are of equal importance, it can be challenging to sift through a large quantity of security threats. Analyzing and acting upon the staggering volume of security threats generated by such an ever-increasing number of cybersecurity operations tools is complex and cumbersome, leading to inefficiencies and vulnerabilities.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including: displaying a first plurality of graphical elements of a graphical user interface (GUI), each graphical element of the first plurality of graphical elements referencing a respective chained outcome of a plurality of chained outcomes of a respective chained rule, wherein the respective chained rule comprises two or more security rules that are linked based on their respective security outcomes; receiving, via the GUI, a selection of a first graphical element of the first plurality of graphical elements, the first graphical element corresponding to a first chained outcome of the plurality of chained outcomes; and displaying a second plurality of graphical elements in a visual association with the first element, each element of the second plurality of elements referencing a respective security outcome of the two or more security rules that are serially linked.

Aspects of the disclosure further include: receiving, via the GUI, a selection of a second element of the second plurality of elements, the second element corresponding to a first security outcome of the two or more security outcomes; and displaying, for the first security outcome, first security data used as input to the first security rule corresponding to the first security outcome.

Aspects of the disclosure further include: wherein the first graphical element corresponding to the first chained outcome is displayed in a timeline view.

Aspects of the disclosure further include: wherein a second graphical element corresponding to a second chained outcome is displayed in the timeline view in a sequence with the first graphical element.

Aspects of the disclosure further include: wherein the sequence is determined by the plurality of chained outcomes.

Aspects of the disclosure further include: wherein linking the two or more security rules based on their respective security outcomes further includes: identifying, based on a predefined criterion, a first metadata item pertaining to a first security outcome of a first security rule of the two or more security rules; identifying, based on the predefined criterion, a second metadata item pertaining to a second security outcome of a second security rule of the two or more security rules; determining, based on the first metadata item and the second metadata item, a first link between the first security rule and the second security rule; and displaying the first security rule, the second security rule, and the first link between the first security rule and the second security rule in the GUI.

Aspects of the disclosure further include: wherein the first metadata item comprises one or more first timestamps, and wherein the second metadata item comprises one or more second timestamps.

Aspects of the disclosure further include: identifying, based on the predefined criterion, a third metadata item pertaining to a third security outcome of a third security rule of the two or more security rules; determining, based on the third metadata item and the first metadata item, a second link between the first security rule and the third security rule; and displaying the first security rule, the third security rule, and the second link between the first security rule and the third security rule in the GUI.

Aspects of the disclosure further include: displaying a secondary graphical element corresponding to the first graphical element in the GUI, wherein the secondary graphical element is displayed in a security response framework.

An aspect of the disclosure provides for a system including a memory and one or more processing devices coupled with the memory, the one or more processing devices to perform the operations including displaying a first plurality of graphical elements of a graphical user interface (GUI), each graphical element of the first plurality of graphical elements referencing a respective chained outcome of a plurality of chained outcomes of a respective chained rule, wherein the respective chained rule comprises two or more security rules that are linked based on their respective security outcomes; receiving, via the GUI, a selection of a first graphical element of the first plurality of graphical elements, the first graphical element corresponding to a first chained outcome of the plurality of chained outcomes; and displaying a second plurality of graphical elements in a visual association with the first element, each element of the second plurality of elements referencing a respective security outcome of the two or more security rules that are serially linked.

Aspects of the disclosure further include: receiving, via the GUI, a selection of a second element of the second plurality of elements, the second element corresponding to a first security outcome of the two or more security outcomes; and displaying, for the first security outcome, first security data used as input to the first security rule corresponding to the first security outcome.

Aspects of the disclosure further include: wherein the first graphical element corresponding to the first chained outcome is displayed in a timeline view.

Aspects of the disclosure further include: wherein a second graphical element corresponding to a second chained outcome is displayed in the timeline view in a sequence with the first graphical element.

Aspects of the disclosure further include: wherein the sequence is determined by the plurality of chained outcomes.

Aspects of the disclosure further include: wherein linking the two or more security rules based on their respective security outcomes further includes: identifying, based on a predefined criterion, a first metadata item pertaining to a first security outcome of a first security rule of the two or more security rules; identifying, based on the predefined criterion, a second metadata item pertaining to a second security outcome of a second security rule of the two or more security rules; determining, based on the first metadata item and the second metadata item, a first link between the first security rule and the second security rule; and displaying the first security rule, the second security rule, and the first link between the first security rule and the second security rule in the GUI.

Aspects of the disclosure further include: wherein the first metadata item comprises one or more first timestamps, and wherein the second metadata item comprises one or more second timestamps.

Aspects of the disclosure further include: identifying, based on the predefined criterion, a third metadata item pertaining to a third security outcome of a third security rule of the two or more security rules; determining, based on the third metadata item and the first metadata item, a second link between the first security rule and the third security rule; and displaying the first security rule, the third security rule, and the second link between the first security rule and the third security rule in the GUI.

Aspects of the disclosure further include: displaying a secondary graphical element corresponding to the first graphical element in the GUI, wherein the secondary graphical element is displayed in a security response framework.

An aspect of the disclosure provides a non-transitory computer readable storage medium including instructions for a server that, when executed by a processing device, cause the processing device to perform operations including: displaying a first plurality of graphical elements of a graphical user interface (GUI), each graphical element of the first plurality of graphical elements referencing a respective chained outcome of a plurality of chained outcomes of a respective chained rule, wherein the respective chained rule comprises two or more security rules that are linked based on their respective security outcomes; receiving, via the GUI, a selection of a first graphical element of the first plurality of graphical elements, the first graphical element corresponding to a first chained outcome of the plurality of chained outcomes; and displaying a second plurality of graphical elements in a visual association with the first element, each element of the second plurality of elements referencing a respective security outcome of the two or more security rules that are serially linked.

Aspects of the disclosure further include: receiving, via the GUI, a selection of a second element of the second plurality of elements, the second element corresponding to a first security outcome of the two or more security outcomes; and displaying, for the first security outcome, first security data used as input to the first security rule corresponding to the first security outcome.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, in accordance with aspects of the disclosure.

FIG. 2 is an example illustration of a security taxonomy, in accordance with aspects of the disclosure.

FIG. 3A is an example block diagram of dataflow for a chain of security rules, in accordance with aspects of the disclosure.

FIG. 3B is an example block diagram of a dataflow for a chain of security rules, in accordance with aspects of the disclosure.

FIG. 4A is a graphical representation of security outcomes organized by a type of security tactic or technique, in accordance with aspects of the disclosure.

FIG. 4B is a graphical representation of security outcomes organized by a type of security tactic or technique, in accordance with aspects of the disclosure.

FIG. 5 illustrates an example GUI element for exploring security rule chains in a security platform, in accordance with aspects of the disclosure.

FIG. 6 illustrates an example method for security rule chaining in a security platform, in accordance with aspects of the disclosure.

FIG. 7A is an example GUI for exploring security rule chains in a security platform, in accordance with aspects of the disclosure.

FIG. 7B is an example GUI for exploring security rule chains in a security platform, in accordance with aspects of the disclosure.

FIG. 7C is an example GUI for exploring security rule chains in a security platform, in accordance with aspects of the disclosure.

FIG. 7D is an example GUI for exploring security rule chains in a security platform, in accordance with aspects of the disclosure.

FIG. 7E is an example GUI for exploring security rule chains in a security platform, in accordance with aspects of the disclosure.

FIG. 7F is an example GUI for exploring security rule chains in a security platform, in accordance with aspects of the disclosure.

FIG. 8 is an example GUI for exploring security rule chains in a security platform, in accordance with aspects of the disclosure.

FIG. 9 is a block diagram illustrating an example of a computer system, according to aspects of the disclosure.

### DETAILED DESCRIPTION

Aspects of the present disclosure relate to security rule chaining in a security platform. A security platform can service one or more clients (e.g., represented by entities such as organizations). The security platform can be part of an online (e.g., virtual) platform that provides clients with a comprehensive suite of productivity tools, programs, and services. The security platform can combine the features of a SIEM and a SOAR into a unified platform. The security platform collects logs from a client and provides the client with tools to detect, analyze, and respond to incidents described in the collected logs. One or more features of the security platform can be automated or partially automated, including log collection actions, incident detection actions, data analysis actions, or incident response actions.

The security platform can provide a client organization with tools to manage computer and network security for the client. The security platform can provide a user (e.g., a systems administrator) from the client organization with a graphical user interface (GUI) to access and use the tools and functionality of the security platform.

The client organization can provide security data (e.g., ingested data) to the security platform. As used herein, security data can include telemetry data such as log files produced by the operating systems, middleware, and/or applications that reflect actions which occurred at specific moments in time on a computing resource. Once the security platform receives the ingested data from the client organization, the client organization can use the tools or services of the security platform to perform security actions with the ingested data. The security actions of the security platform can generate one or more of events, detections, or alerts from the ingested data. Some security platforms can provide notifications based on the events, detections or alerts that are generated.

In some instances, the frequency, or quantity of events, detections, or alerts that are generated by the security platform can be configured by the client organization. For example, a client organization can prioritize alerts that are triggered by accessing a certain resource. However, some alerts when viewed or analyzed in isolation may not be indicative of a security threat, but when analyzed in connection with additional alerts, detections, events, or other security data the combined dataset may indicate a potential security threat to the client organization using the security platform. Often, lower-priority detections may not trigger an alert (in order to reduce the number of alerts provided to a client organization). Alternatively, detections may trigger an alert, but the alert is suppressed based on a certain alert threshold condition (e.g., by the security platform or client organization) in favor of alerts that have satisfied the certain alert threshold condition. This can allow a sophisticated malicious actor to perform multiple lower-threat activities that may go undetected to accomplish their goal to breach and/or compromise a computing environment of the client organization. The malicious actor can perform these activities in ways that can be difficult for the security platform to connect. For example, a collection of events, detections, and/or alerts may appear to be unconnected, particularly if the malicious actor is using new, or little-known tactics. If the collection of events, detections and/or alerts fall below notification thresholds for the organization, it is possible that additional analysis will not be performed to determine that the collection of events, detections, and/or alerts are connected to the same security threat. However, if the notification threshold for the organization is set so low that nearly every security rule that is applied to security data generates a notification, the organization may receive more notifications than can be truly processed (e.g., including false positives), and notifications about genuine security threats can easily be buried.

Aspects of the present disclosure address the above noted and other deficiencies by providing rule chaining in a security platform. A security rule of the security platform can be applied to the security data provided by a client organization to the security platform. As used herein, a “security rule” refers to a defined set of criteria (e.g., one or more logical conditions) and instructions (e.g., one or more security actions) used to process security data and/or outcomes from other security rules in order to identify, classify, and respond to security incidents.

When a security rule is applied to security data, the security data is evaluated against the logical condition. If the security data satisfies the logical condition, the action specified by the security rule is performed, thus producing the outcome of the rule. The outcome from the security rule can be one or more of an event, a detection (e.g., of a security threat), an alert (e.g., of a security threat), a corrective action to be performed (e.g., modification of a configuration of an entity referenced by the rule, such as a computer system), or the like.

For example, security data can reflect that a user has attempted to login to services provided by the client organization ten times in the past five minutes. A security rule can include a logical condition regarding a number of login attempts within a certain time period (e.g., ten login attempts in five minutes), and an action to be performed responsive to the logical condition being satisfied (e.g., the user will be prevented from login attempts for ten minutes). When the security data is processed by the security rule, the ten login attempts in five minutes reflected in the security data can satisfy the condition in the security data, and the security action will be performed to prevent the user from attempting additional login attempts for ten minutes.

Security rules can be chained together by enabling security rules to process security data and/or one or more security outcomes. In some embodiments, chains of security rules can be identified or constructed based on common characteristics between outcomes from security rules. For example, a first security rule can use first security data to generate an first outcome indicating that a user has attempted to login too many times in ten minutes, and as a result, login attempts for the user have been suspended. A second security rule can use the first outcome and multiple additional outcomes from the same rule that was performed on security data pertaining to different users to generate a second outcome indicating that login attempts have been suspended for multiple users based on too many login attempts over a set time period, which indicates that a security threat is likely.

In some embodiments, rules can be chained together such that outcomes from a final rule in the chain can be used to perform a security action. Intermediate outcomes (e.g., from rules within the chain) can be used to chain one rule to the next, and the final outcome that is not chained to the input of another rule can be used to determine a security action. In some embodiments, the final outcome of the chain of security rules can be presented to the client organization through a GUI of the security platform. In some embodiments, the final outcome of the chain of security rules can be evaluated against a threshold criterion. If the final outcome of the chain satisfies the threshold criterion, a security action can be performed, such as notifying the client organization of the final outcome, one or more preventative actions, mitigation actions, or the like.

Chains of security rules can be defined by the platform and/or by the client organization. Defining a chain of two security rules may involve specifying which rule outcome(s) that will be used as inputs to another security rule. In some embodiments, two or more outcomes from two or more security rules can be used as an input to another security rule. In some embodiments, multiple rules can be chained together. For example, a first security rule can generate a first security outcome, which is used as a portion of input to a second security rule to generate a second security outcome, which second security outcome is used as a portion of input to a third security rule to generate a third security outcome, and so for. In some embodiments, suggested chains of security rules can be provided by the security platform to the client organization based on one or more of security platform data (e.g., data from multiple client organizations that use the security platform), anonymized client organization data (e.g., client organizations in the same business sector that use the security platform), open source security standards, security best practices, or the like.

In some embodiments, additional metadata can be added to each outcome generated by a security rule. This additional metadata can include a data wrapper, a label, a processing timestamp, or the like. In some embodiments, the additional metadata can be referred to as “client-added,” or “client-specific” metadata. For example, the client organization can specify a security rule identifier for a security rule. In some embodiments, the outcomes can each have certain characteristics (e.g., original metadata). For example, a type of action performed, temporal data, network data, etc. In some embodiments, security rules in a chain, or chains of security rules can be grouped or classified based on the metadata (original or client-added) of each outcome.

Security rules can be single-variate or multi-variate. A single-variate security rule can input a single variable or a datapoint to identify a potential security incident. Single-variate security rules can be processed quickly and can be very effective against certain well-known security issues, such as brute-force attacks, unauthorized login or access attempts, or sudden spikes in network traffic (e.g., a distributed denial-of-service (DDOS) attack). However, single-variate security rules may generate a high number of false positives A multi-variate security rule can observe multiple variables to identify a potential security incident. Multi-variate security rules are processed more slowly in comparison to single-variate security rules, but are less likely to generate false positives. However, sometimes the processing time to perform a multi-variate security rule can be prohibitive. For example, if a multi-variate security rule has a 99% accuracy rate at detecting a network intrusion, but takes 48 hours to process, the network intrusion may have happened and the malicious actor may have already compromised the computing environment of the client organization, rendering the 99% accurate detection of the network intrusion useless.

Advantages of implementing security rule chaining chaining in a security platform include improving detection rates of security threats, reducing security threat notification clutter, reducing unnecessary alerts provided to the client organization, and improving the configurability of security rules for the client organization. Additionally, single-variate security rules or lower-order multi-variate security rules (e.g., 2-3 variables) can be performed much more quickly than large multi-variate security rules. By chaining multiple “smaller” rules together as described above, the same or similar outcomes can be achieved with less processing time, leading to faster identification of security threats, and more meaningful security response actions to the security threats. For example and in some embodiments, multiple security rules can be processed in parallel, and the outcomes of each of the simultaneously processed security rules can be used for multiple secondary security rules—each of which can be processed in parallel. These improvements can lead to an overall improved security of the computing environment of the client organization through improved functionality of security platform tools and features available to clients.

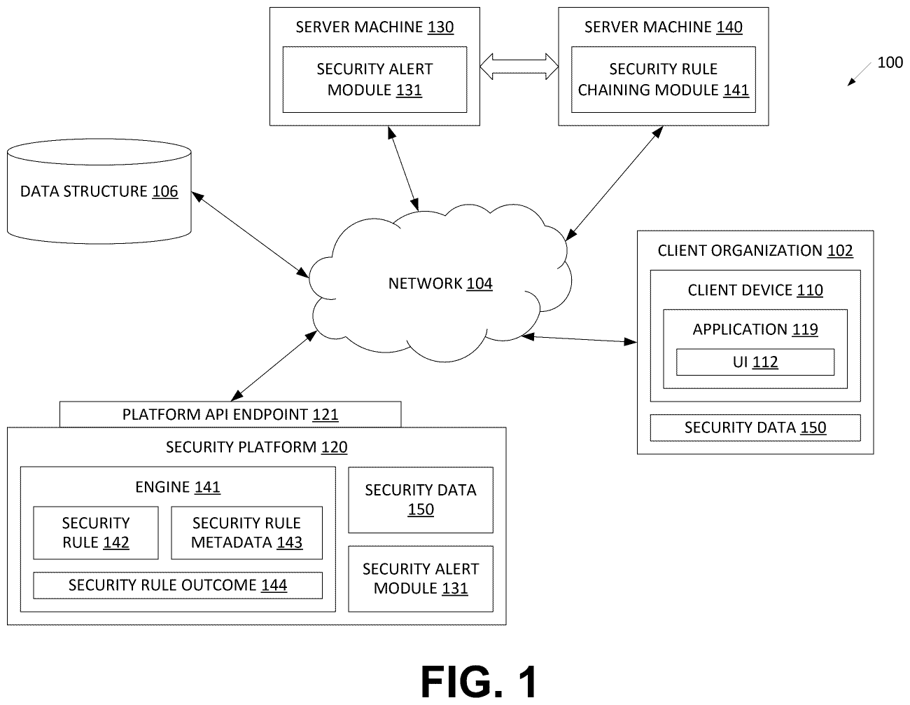

FIG. 1 illustrates an example of a system 100, in accordance with aspects of the disclosure. The system 100 includes a security platform 120, one or more server machines 130-140, a data structure 106, and client organization 102 connected to network 104. In some embodiments, system 100 can include one or more other platforms (not illustrated).

In some embodiments, network 104 can include a public network (e.g., the Internet), a private network (e.g., a local area network (LAN) or wide area network (WAN)), a wired network (e.g., Ethernet network), a wireless network (e.g., an 702.11 network or a wireless fidelity (Wi-Fi) network), a cellular network (e.g., a Long Term Evolution (LTE) network), routers, hubs, switches, server computers, and/or a combination thereof.

Data structure 106 can be a persistent storage that is capable of storing data such as log information (e.g., sequences of characters in a log), labels reflecting a type of log, and the like. Data structure 106 can be hosted by one or more storage devices, such as main memory, magnetic or optical storage based disks, tapes or hard drives, network-attached storage (NAS), storage area network (SAN), and so forth. In some embodiments, data structure 106 can be a network-attached file server, while in other embodiments the data structure 106 can be another type of persistent storage such as an object-oriented database, a relational database, and so forth, that can be hosted by security platform 120, or one or more different machines coupled to the server hosting the security platform 120 via the network 104. In some embodiments, data structure 106 can be capable of storing one or more data items, as well as data structures to tag, organize, and index the data items. A data item can include various types of data including structured data, unstructured data, vectorized data, etc., or types of digital files, including text data, audio data, image data, video data, multimedia, interactive media, data objects, and/or any suitable type of digital resource, among other types of data. An example of a data item can include a file, database record, database entry, programming code or document, among others.

The client organization 102 can include one or more client device(s) (e.g., client device 110). Each client device 110 can include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. In some embodiments, client device(s) may also be referred to as a “user device” herein. Although a single client device 110 is shown for purposes of illustration rather than limitation, one or more client devices can be implemented in some embodiments. Client device 110 will be referred to as client device 110 or client devices 110 interchangeably herein.

In some embodiments, a client device, such as client device 110, can implement or include one or more applications. In some embodiments, application 119 can be used to communicate (e.g., send and receive information) with the security platform 120. In some embodiments, application 119 can implement user interfaces (UIs) (e.g., graphical user interfaces (GUIs)), such as a user interface (UI) (e.g., UI 112) that may be webpages rendered by a web browser and displayed on the client device 110 in a web browser window. In another embodiment, the UIs 112 of client application, such as application 119 may be included in a stand-alone application downloaded to the client device 110 and natively running on the client device 110 (also referred to as a “native application” or “native client application” herein). In some embodiments, engine 141 can be implemented as part of application 119. In other embodiments, engine 141 can be separate from application 119 and application 119 can interface with engine 141.

In some embodiments, one or more client devices 110 can be connected to the system 100. In some embodiments, client devices, under direction of the security platform 120 when connected, can present (e.g., display) a UI 112 to a user of a respective client device through application 119. The client devices 110 may also collect input from users through input features.

In some embodiments, a UI 112 may include various visual elements (e.g., UI elements) and regions, and can be a mechanism by which the user engages with the security platform 120, and system 100 at large. In some embodiments, the UI 112 of a client device 110 can include multiple visual elements and regions that enable presentation of information, for decision-making, content delivery, etc. at a client device 110. In some embodiments, the UI 112 may sometimes be referred to as a graphical user interface (GUI)).

In some embodiments, the UI 112 and/or client device 110 can include input features to intake information from a client device 110. In one or more examples, a user of client device 110 can provide input data (e.g., a user query, control commands, etc.) into an input feature of the UI 112 or client device 110, for transmission to the security platform 120, and system 100 at large. Input features of UI 112 and/or client device 110 can include space, regions, or elements of the UI 112 that accept user inputs. For example, input features may include visual elements (e.g., GUI elements) such as buttons, text-entry spaces, selection lists, drop-down lists, etc. For example, in some embodiments, input features may include a chat box which a user of client device 110 can use to input textual data (e.g., a user query). The application 119 via client device 110 can then transmit that textual data to security platform 120, and the system 100 at large, for further processing. In other examples, input features can include a selection list, in which a user of client device 110 can input selection data e.g., by selecting, or clicking. The application 119 via client device 110 can then transmit that selection data to security platform 120, and the system 100 at large, for further processing.

In some embodiments, a client device 110 can access the security platform 120 through network 104 using one or more application programming interface (API) calls via platform API endpoint 121. In some embodiments, security platform 120 can include multiple platform API endpoints 121 that can expose services, functionality, or information of the security platform 120 to one or more client devices 110. In some embodiments, a platform API endpoint 121 can be one end of a communication channel, where the other end can be another system, such as a client device 110 associated with a user account. In some embodiments, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some embodiments, HTTP (Hypertext Transfer Protocol), HTTPS (Hypertext Transfer Protocol Secure) methods (e.g., API calls) can be used to communicate to and from the platform API endpoint 121.

In some embodiments, the platform API endpoint 121 can function as a computer interface through which access requests are received and/or created. In some embodiments, the platform API endpoint 121 can include a platform API whereby external entities or systems can request access to services and/or information provided by the security platform 120. The platform API can be used to programmatically obtain services and/or information associated with a request for services and/or information.

In some embodiments, the API of the platform API endpoint 121 can be any suitable type of API such as a REST (Representational State Transfer) API, a GraphQL API, a SOAP (Simple Object Access Protocol) API, and/or any suitable type of API. In some embodiments, the security platform 120 can expose through the API, a set of API resources which when addressed can be used for requesting different actions, inspecting state or data, and/or otherwise interacting with the security platform 120. In some embodiments, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the security platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some embodiments, any element, such as server machine 130, server machine 140, and/or data structure 106 may include a corresponding API endpoint for communicating with APIs.

In some embodiments, the security platform 120 may include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security platform 120 can include a plurality of computing devices that together may comprise a hosted computing resource, a grid computing resource, or any other distributed computing arrangement. In some embodiments, the security platform 120 can correspond to an elastic computing resource where the allotted capacity of processing, network, storage, or other computing-related resources may vary over time.

In some embodiments, the security platform 120 can include one or more features to collect, analyze, and respond to security data 150 received from a client organization 102. The security platform can collect the security data 150 from the client organization 102. In some embodiments, the security platform 120 includes one or more security data ingestion points. In some embodiments, one or more aspects of the collection of the security data 150 the client organization 102 are automated or partially automated. In some embodiments, the security data 150 can be stored in the data structure 106. The security platform 120 can provide the client organization 102 with tools to analyze the security data 150.

Security data 150 can be generated by the client organization 102 and can include information describing activities in a computing environment of the client organization 102 (e.g., including client device 110, application 119, etc.). In some embodiments, the security data 150 includes details about the activity that the client organization 102 can use to analyze the activity, respond to an event, or implement policies to avoid, or promote similar activity in the future. In some embodiments, tools, applications, or systems of or used by the client organization 102 can generate security data 150. In some embodiments, the security platform 120 can receive security data 150 generated by a client organization 102. For example, and in some embodiments, the client organization 102 can provide the security platform 120 with security data 150 as an automated or semi-automated process. In some embodiments, the security data 150 are received one at a time. In some embodiments, the security data 150 are received as a list, group, table, or other data structure. In some embodiments, one or more of security data 150 are received discreetly (e.g., at specific times). In some embodiments, the security data 150 are received as a real-time data stream.

In some embodiments, the security data 150 includes one or more entries, such as temporal data (e.g., a timestamp), an event description, network data (e.g., internet protocol (IP) address(es), network traffic data, or network configuration data), a user identification, system information (e.g., a computing environment of the client), security context information, or the like. In some embodiments, the security data 150 includes information related to the client organization 102. For example, security data 150 from Organization A using Application X can include Organization A information and Application X information, while security data from Organization B using Application X may only include Application X information. In some embodiments, the security data 150 can include organization-specific data. In some embodiments, a portion of the security data 150 for logs received from different organizations (e.g., client organization 102) can be the same or similar.

In some embodiments, the security data can be labeled or tagged to allow, e.g., efficient correlation of various data items that may be related to a common set of entities and/or may share a common set of parameters. In some embodiments, one or more aspects of the tools to analyze the information extracted from the security data 150 can be automated or partially automated. The security platform 120 can provide the client organization 102 with tools to perform one or more security actions based on information extracted from the security data 150 received from the client organization 102. In some embodiments, the security platform 120 can allow the client organization 102 to configure certain security response parameters related to performing one or more actions based on information extracted from the security data 150. For example, the security platform 120 can allow the client to indicate a particular security action that is to be triggered when a chain of security rules terminates (e.g., the final security rule in the chain of security rules produces an outcome). In some embodiments, one or more aspects of the tools to perform one or more actions based on the information extracted from the security data 150 can be automated or partially automated.

The security platform 120 can implement a engine 141. The engine 141 can implement one or more features and/or operations as described herein. In some embodiments, engine 141 can include or access an artificial intelligence (AI) model (e.g., a machine learning model) to perform the one or more features and/or operations (not illustrated). In some embodiments, the security platform 120 receives security data 150 from the client organization 102. Security data 150 can include data that pertains to security data (e.g., security logs) received from the client organization 102. The engine 141 can process the security data 150 to obtain a security rule outcome 144. In some embodiments, the engine 141 can process additional inputs, including security rule metadata 143, and security rule outcomes 144 from previously performed security rules 142. The engine 141 can include or interface with a GUI (e.g., UI 112) to provide users of a client device 110 of a client organization 102 with a user interface to configure one or more parameters of the engine 141. For example, the UI 112 can be used to define a chain of security rules. In some embodiments, security rule metadata 143 can include one or more of data type identifiers, rule type identifiers, specific rule identifiers, outcome type identifiers, data labels, rule labels, a source of the security data 150, or the like.

The security platform 120 can feed the security data 150 to a security rule engine (e.g., engine 141). In some embodiments, the engine 141 applies one or more of the security rules 142 to one or more subsets of the ingested security data. In some embodiments, the engine 141 can generate inputs for training an AI model to predict rule-chaining characteristics (not illustrated). In some embodiments, the client organization 102 configures parameters of the security platform 120 based on one or more security rules in a chain of security rules. Each security rule chain can be configured individually, e.g., via manipulating visual objects and controls rendered by a graphical user interface and/or creating or editing formal rule definitions in a predefined scripting language. Once a chain of security rules is configured, the chain can automatically be applied to the ingested data.

In an illustrative example, the engine 141 can provide an outcome from the chain of security rules (e.g., a last outcome from the last security rule in the chain of security rules) to the security alert module 131 of the security platform 120. In some embodiments, the security alert module 131 can generate one or more notifications for the respective outcomes of the chain of security rules. For example, the security alert module 131 can generate one notification (e.g., an “alert”) for the entire chain of security rules. In another example, the security alert module 131 can also generate notifications for certain intermediate outcomes triggered by the chain of security rules, as defined by the security platform 120 and/or the client organization 102. In some embodiments, the security alert module 131 can suppress alerts generated by security rules in the chain of security rules, and only provide a notification of the final outcome of the chain of security rules to a user interface (e.g., UI 112) of a client organization 102.

Security rule outcomes 144 can represent the outcome from a security rule 142. In some embodiments, a chain of the security rules 142 can be represented as a chain of security rule outcomes 144 that each pertain to a respective security rule (e.g., a security rule 142). For example, an first outcome can be represented, and a second outcome can be shown (indicated) as stemming from the first outcome, establishing a link between the first outcome and the second outcome. As described above, these chaining links (e.g., the chains of the security rules 142) can be defined by the client organization 102, and/or the security platform 120.

In some embodiments, the engine 141 can group one or more of the security rules 142, one or more chains of the security rules 142, one or more security rule outcomes 144, one or more chains of the security rule outcomes 144, or security data 150 based on shared metadata (e.g., security rule metadata 143) based on shared characteristics (e.g., labels, metadata, file wrappers, timestamps, etc.). The security rule metadata 143 can include one or more characteristics (e.g., data type, temporal data, access type, etc.) and/or additional information that can be added by a security rule 142 (e.g., security rule processing time, processing wrapper information, etc.). The engine 141 can determine whether metadata from the security rules 142, chain of the security rules 142, security rule outcomes 144 or security data 150 is shared. Upon determining a commonality, the security rules 142, chains of the security rules 142, security rule outcomes 144, chains of the security rule outcomes 144, and/or security data 150 can be grouped based on the commonality.

For example and in some embodiments, security data 150 can indicate an access time, and a security rule outcome 144 can have associated metadata indicating a processing time (e.g., a time that the corresponding security rule was used on security data to produce the security rule outcome). The engine 141 can group the security data 150 and the security rule outcome 144 based on the common (e.g., shared, same, or similar) temporal data (e.g., the access time and the processing time). In some embodiments, the data can be grouped sequentially as a series of events.

In some embodiments, the data can be grouped based on a temporal similarity (e.g., how close together the events have occurred). Additional groupings are also considered, including for example, detection types, data types, data labels, data access types, computing devices, network activity or location, and the like.

In some embodiments, the engine 141 (e.g., via the security platform 120) can generate, modify, and monitor the client-side UIs (e.g., graphical user interfaces (GUI)) and associated components that are presented to users of the security platform 120 through UI 112 client devices 110. For example, engine 141 can generate the UIs (e.g., UI 112 of client device 110) that users interact with while engaging with the security platform 120.

In some embodiments, a machine learning model (e.g., also referred to as an “artificial intelligence (AI) model” herein) can include a discriminative machine learning model (also referred to as “discriminative AI model” herein), a generative machine learning model (also referred to as “generative AI model” herein), and/or other machine learning model.

In some embodiments, a discriminative machine learning model can model a conditional probability of an output for given input(s). A discriminative machine learning model can learn the boundaries between different classes of data to make predictions on new data. In some embodiments, a discriminative machine learning model can include a classification model that is designed for classification tasks, such as learning decision boundaries between different classes of data and classifying input data into a particular classification. Examples of discriminative machine learning models include, but are not limited to, support vector machines (SVM) and neural networks.

In some embodiments, a generative machine learning model learns how the input training data is generated and can generate new data (e.g., original data). A generative machine learning model can model the probability distribution (e.g., joint probability distribution) of a dataset and generate new samples that often resemble the training data. Generative machine learning models can be used for tasks involving image generation, text generation and/or data syn-thesis. Generative machine learning models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

In some embodiments, server machine 130 and server machine 140 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to one or more data items of the security platform 120. The security platform 120 can also include a website (e.g., a webpage) or application back-end software that can be used to provide users with access to the security platform 120.

In some embodiments, one or more of the server machine 130 or the server machine 140 can be part of the security platform 120. In other embodiments, one or more of the server machine 130 or the server machine 140 can be separate from security platform 120 (e.g., provided by a third-party service provider).

In general, functions described in implementations as being performed by security platform 120, client organization 102, and/or server machine 140 can also be performed on the client device 110 in other implementations, if appropriate. In addition, the functionality attributed to a specific component can be performed by different or multiple components operating together. The security platform 120 can also be accessed as a service provided to other systems or devices through appropriate application programming interfaces, and thus is not limited to use in websites.

In implementations of the disclosure, a “user” can be represented as a single individual. For example, a user of the client device 110. However, other implementations of the disclosure encompass a “user” being an entity controlled by a set of users and/or an automated source (e.g., client organization 102). For example, a set of individual users federated as a community in a social network can be considered a “user.” In another example, an automated consumer can be an automated ingestion pipeline of security platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a specific location of a user cannot be determined. Thus, the user can have control over what information is collected about the user, how that information is used, and what information is provided to the user.

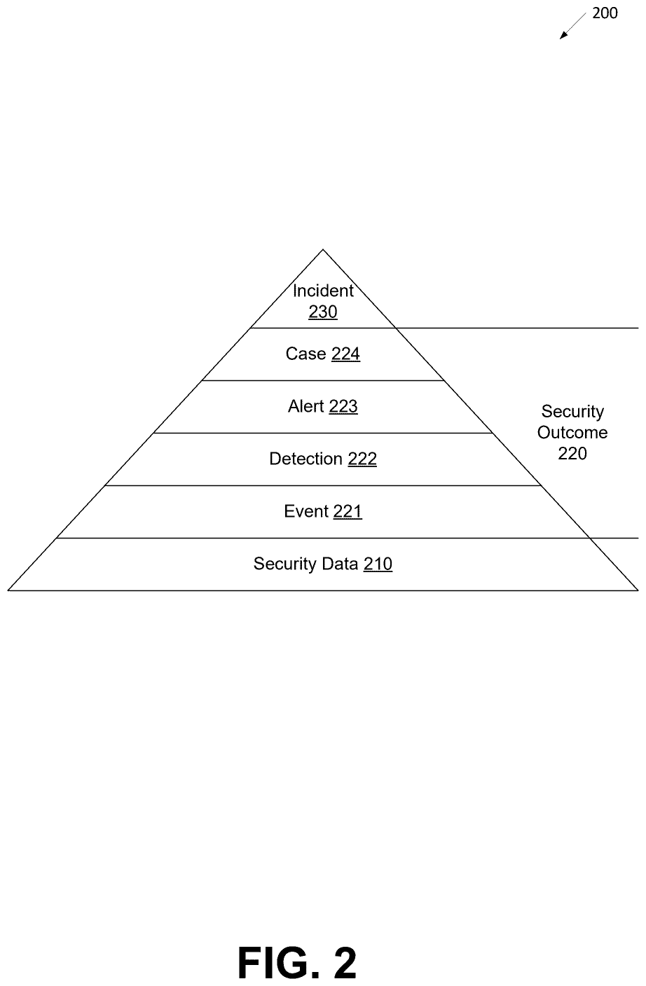

FIG. 2 is an example illustration of a security taxonomy 200, in accordance with aspects of the disclosure. Security taxonomy 200 includes security data 210, event 221, detection 222, alert 223, case 224, and incidents 230. As used herein, security outcome 220 can include one or more of an event 221, a detection 222, an alert 223, or a case 224. Generally, incidents 230 can refer to any of one or more of an event 221, a detection 222, an alert 223, or a case 224 that exceeds a threat-level threshold condition, as defined by the security platform and/or an organization using the security platform. In some embodiments, security outcome 220 can include incidents 230. It can be appreciated that the security taxonomy 200 is included herein to define, and provide examples of “security outcomes” (e.g., security outcome 220), which is meant to be an inclusive representation and definition, rather than an exclusive representation and definition.

Security data 210 can include all data generated by an organization (e.g., client organization 102) that is sent to a security platform (e.g., security platform 120) for processing (e.g., ingested data). As described above, security data 210 can include telemetry data. The security platform can process the security data 210 using one or more security rules. As described above, a security rule is a defined set of criteria and instructions used to process the security data (and/or outcomes from other security rules). Security data 210 can be processed by a security rule into a security outcome 220, which can include one or more of an event 221, a detection 222, an alert 223, or a case 224. In some embodiments, once security data 210 is processed by a security rule, the resulting data is a security outcome 220 (e.g., one of an event 221, a detection 222, an alert 223, or a case 224), or an incident 230.

The security platform can process the event 221 using one or more security rules. An event 221 can refer to security data 210 that has been processed to include additional context or significance that indicates a noticeable change in the state of a computing system. In some embodiments, the additional context or significance can be included or represented as a label or tag. In some embodiments, the additional context or significance can be added as metadata to the processed security data (e.g., security data 210) to generate the event 221. In some embodiments, multiple sets of security data 210 can be processed by a single security rule to generate an event 221. An event 221 can be processed by a security rule into another security outcome 220, including one or more of another security event (e.g., event 221), a detection 222, an alert 223, or a case 224. In some embodiments, the event 221 can be processed into an incident 230.

The security platform can process the detection 222 using one or more security rules. A detection 222 can refer to an object that is generated from matched or correlated security events (e.g., event 221) that pertains to an indication, or potential indication of a security threat. A detection 222 can include an analytical assessment of an event 221, and/or security data 210. In some embodiments, data used to generate the detection 222 (e.g., security data 210, event 221, another detection, etc.) can be matched or correlated by an algorithm or machine learning model. In some embodiments, the detection 222 can be generated from a security rule based on security data 210. In some embodiments, the detection 222 can be generated from a security rule based on event 221 and security data 210. Detection 222 can be processed by a security rule into another security outcome 220, including one or more of another security detection (e.g., a detection 222), an alert 223 or a case 224. In some embodiments, detection 222 can be processed into an incident 230.

The security platform can process the alert 223 using one or more security rules. An alert 223 can refer to a security outcome 220 that satisfies an alert threshold criterion. An alert 223 can be a detection 222 that satisfies the alert threshold criterion. In some embodiments, the security outcome 220 can satisfy an alert threshold based on one or more characteristics of the security outcome 220. Characteristics of security outcomes 220 can be reflected in metadata associated with the security outcome 220. In some embodiments, a security rule can process one or more of security data 210, an event 221, a detection 222, or other alert 223 to determine whether the processed data satisfies the alert threshold. An alert 223 can be processed by a security rule into another security outcome 220, including one or more of another security alert (e.g., an alert 223) or a case 224. In some embodiments, the alert 223 can be processed into an incident 230.

The security platform can process the case 224 using one or more security rules. A security case (e.g., case 224) can refer to a collection of one or more security alerts (e.g., alert 223), detections (e.g., detection 222), events (e.g., event 221), and/or security data 210 that have one or more of the same or similar characteristics (e.g., metadata). In some embodiments, case 224 can be grouped based on temporal characteristics. For example, security outcomes 220 and security data 210 can be grouped into case 224 based on an access time, or processing time associated with the security outcomes 220 or security data 210. Case 224 can be processed by a security rule into another security outcome 220 such as another security case (e.g., case 224). In some embodiments, the case 224 can be processed into an incident 230.

The security platform can process an incident 230 based on one or more security rules. An incident 230 can refer to a security outcome 220 that meets one or more criteria for investigation. In some embodiments, the investigation that is triggered for the incident 230 can be a manual investigation by security researchers. In some embodiments, the investigation that is triggered for the incident 230 can be an automated or semi-automated investigation using one or more of security investigation algorithms, artificial intelligence (AI) models, or the like.

As described herein with reference to FIG. 2, a security outcome 220 can include one or more of an event 221, a detection 222, an alert 223, or a case 224. In some embodiments, a security outcome 220 can include an incident 230. Security outcomes 220 can be generated by one or more security rules that process one or more of security data 210, an event 221, a detection 222, an alert 223, or a case 224. For example, a security rule can process the security data 210, a detection 222, and an alert 223 to generate a security outcome 220. In another example, a security rule can process a detection 222 to generate a security outcome 220. In another example, a security rule can process the security data 210 to generate a security outcome 220. In some embodiments, security outcomes 220 can be generated by security rules that additionally process data from an incident 230. For example, a security outcome 220 (e.g., a security detection) can be obtained by processing the security data 210 and a detection 222 on a security platform using a security rule. In another example, a security outcome 220 (e.g., a security event) can be obtained by processing the security data 210 and an event 221. In another example, a security outcome 220 (e.g., a security alert) can be obtained by processing the event 221, the detection 222, and the alert 223. Thus, it can be appreciated that security rules can operate on security data 210 and any of security outcomes 220 to produce another security outcome 220. In some embodiments, security outcomes 220 of a lower tier on the security taxonomy 200 are processed by a security rule to generate security outcomes 220 of the same, or a higher tier. For example, event 221 and detection 222 can be processed by a security rule to generate additional detection 222, or alert 223.

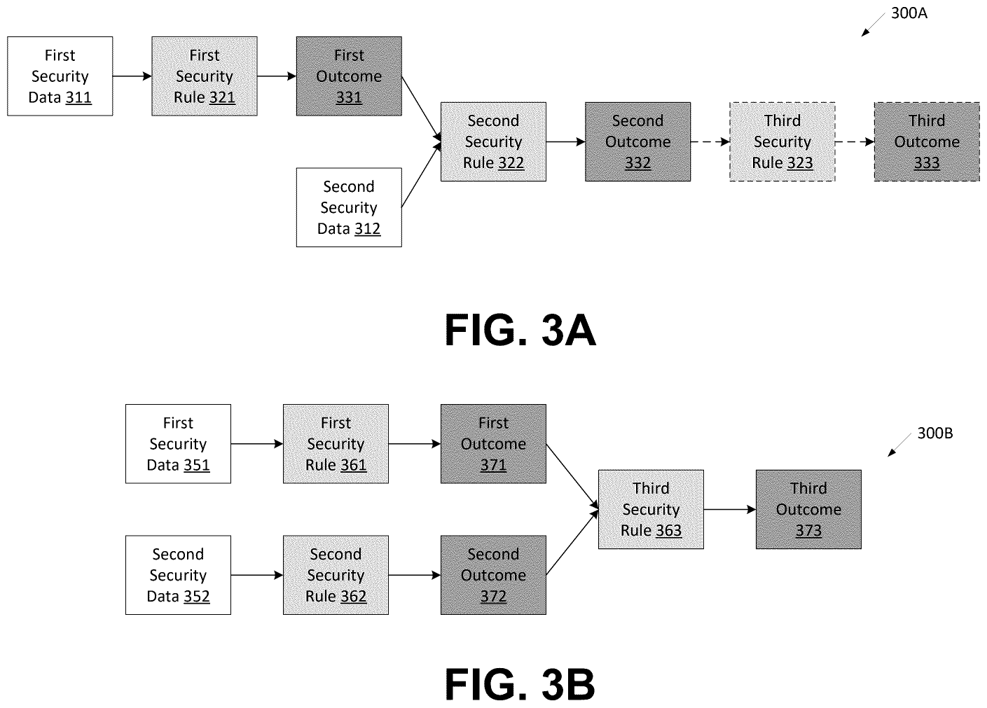

FIG. 3A is an example block diagram of dataflow 300A for a chain of security rules, in accordance with aspects of the disclosure. The dataflow 300A shows a chain of security rules in light gray, including a first security rule 321 chained to a second security rule 322. A third security rule 323 is illustrated in dashed lines to show an optional n-th number of chained rules. The dataflow 300A similarly shows a chain of security rule outcomes in dark gray, including a first outcome 331 and a second outcome 332. A third outcome 333 is illustrated in dashed lines to show an optional n-th number of chained outcomes. As illustrated, the outcomes of each security rule can be used as input to a subsequent security rule.

First security data 311 can be used by a first security rule 321 to obtain a first outcome 331. The first outcome 331 and second security data 312 can be used by a second security rule 322 to obtain a second outcome 332. Security rules (e.g., first security rule 321, second security rule 322, etc.) can be configured to be performed on security data, and/or outcomes from previously performed security rules. In some embodiments, the security data and the outcomes from previously performed security rules can be formatted in the same or similar style, or form. In some embodiments, the security data and outcomes from previously performed security rules can be saved in the same data structure (e.g., data structure 106). In some embodiments, security data and security rule outcomes can be stored in separate data structures, which may be accessed or referenced by one or more security rules.

In some embodiments, the first security data 311 and the second security data 312 are different. In some embodiments, the first security data 311 includes information from multiple security logs received from the client organization. The first security data 311 can represent an aggregated dataset of multiple security logs that include the same type of security data. For example, security data can include information that reflects login attempts by multiple users on the same machine. In another example, security data can include information that reflects login attempts by the same user on multiple machines.

In illustrative example dataflow for the dataflow 300A of the chain of security rules, the first security data 311 includes information reflecting login attempts by a first user on a first machine and the second security data 312 includes information reflecting a total number of failed login attempts over a certain period of time. The first security rule 321 can use the first security data 311 to obtain a first outcome 331, e.g., that a first user has made five failed login attempts on the same machine within the past minute. The second security rule 322 can use the first outcome 331 and second security data 312 to obtain a second outcome 332, e.g., that five of the seven failed login attempts for the organization within the past minute were from the same user. This can be compared to an expected (e.g., historical) number of failed login attempts at any given time, and a proportional amount of failed login attempts by any user of the total quantity of failed login attempts at any given time. For example, if the organization typically (e.g., historically) has one failed login attempt every minute, five out of seven failed login attempts in one minute may indicate a security incident.

FIG. 3B is an example block diagram of a dataflow 300B for a chain of security rules, in accordance with aspects of the disclosure. The dataflow 300B shows a chain of security rules in light gray, including a first security rule 361 and a second security rule 362 chained to a third security rule 363. The dataflow 300B similarly shows a chain of security rule outcomes in dark gray, including a first outcome 371 and a second outcome 372 chained to a third outcome 373. As illustrated, the outcomes of each security rule can be used as input to a subsequent security rule.

First security data 351 can be used by a first security rule 361 to obtain a first outcome 371. Second security data 352 can be used by a second security rule 362 to obtain a second outcome 372. The first outcome 371 and the second outcome 372 can be used by a third security rule 363 to obtain a third outcome 373. Security rules (e.g., first security rule 361, second security rule 362, third security rule 363 etc.) can be configured to be performed on security data, and/or outcomes from previously performed security rules.

In some embodiments, the first security data 351 and the second security data 352 are the same type of data (e.g., user login attempts) with different values or associated metadata (e.g., for different users). In another illustrative example flow for the chain of dataflow 300B, the first security data 351 includes information reflecting login attempts by a first user within a certain time period, and the second security data 352 includes information reflecting login attempts by a second user within a certain time period. The first security rule 361 can obtain a first outcome 371, e.g., that there were five failed user login attempts for a first user within the past ten minutes. The second security rule 362 can obtain a second outcome 372, e.g., that there were five failed user login attempts for a second user within the past ten minutes. The third security rule 363 can use the first outcome 371 and the second outcome 372 to obtain a third outcome 373, e.g., that two users had five failed login attempts in the past ten minutes. This third outcome 373 can be used to perform a security action. In some embodiments, the security action is performed if the third outcome 373 satisfies a threshold criterion.

It can be appreciated that additional rule chaining operations are considered. For example, returning to FIG. 3A, second security data 312 can reflect an aggregation of multiple outcomes from respective security rules (not illustrated) that were applied to security data received from the organization (e.g., client organization 102 of FIG. 1).

Security rules can operate on security data (e.g., as illustrated in FIG. 3A with first security data 311 and first security rule 321), as well as on security data in combination with security rule outcomes (e.g., as illustrated in FIG. 3A with first outcome 331, second security data 312, and second security rule 322), as well as on multiple outcomes from respective security rules (e.g., as illustrated in FIG. 3B with first outcome 331, second outcome 332, and third security rule 363).

Another example of security rule chaining relates to examining actions performed by users who are out of the office (OOO). A first security rule can run periodically (e.g., once per day) and stores a list of identifiers for currently out of the office employees. In some embodiments, the list (e.g., the outcome from the first-run security rule) can include additional information such as a hostname of the user's machine, an employee's job function, or a privilege level of the user's machine. Subsequently, the stored list of out of the office employees can be used in subsequent rules (e.g., chained rules) when checking whether a user performed a specific action or engaged in a certain behavior. This chaining of rules prevents duplication of processing that may otherwise occur in large multi-variate rules that may compute (e.g., check) which users are OOO as one part of performing the multi-variate rule.

Another example of security rule chaining would enable security data, security rule outcomes, and additional related information (e.g., associated metadata, etc.) to be labeled. A first security rule can run periodically (e.g., once per hour) to label all newly received security data (e.g., security data received in the past hour). A second security rule can run periodically (e.g., once per hour) to label all newly obtained security rule outcomes (e.g., security rule outcomes obtained in the past hour). A third security rule can run periodically (e.g., once per day) to organize or group security data and security rule outcomes based on the labels generated by the first and second security rules.

In some embodiments, rule chaining as illustrated in FIG. 3A and FIG. 3B is performed on security rule outcomes (e.g., first outcome 331) and security rule data (e.g., second security data 312) that share a common characteristic. For example, with reference to FIG. 3A, the first outcome 331 can pertain to a first user, and the second security data 312 can also pertain to the first user. In another example, with reference to FIG. 3B, the first outcome 331 can pertain to a first user login attempt of a first service, and the second outcome 332 can pertain to a second user login attempt of the first service. As described above, common characteristics can include one or more of the same user/host, same computing device, same or similar network information, same or similar type of access, same or similar type of data, same or similar access time (or other temporal data), or the like.

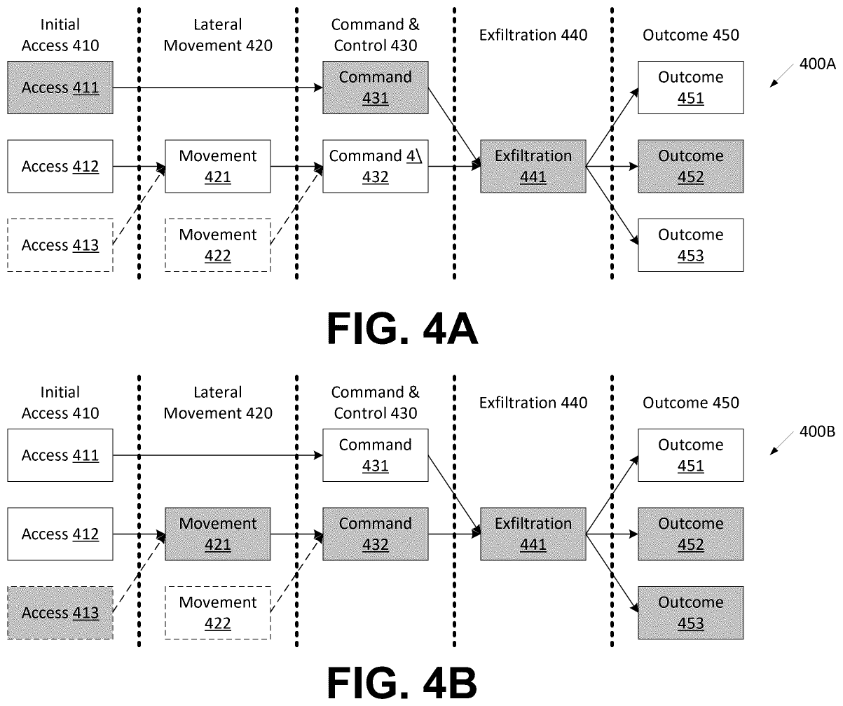

FIG. 4A is a graphical representation of security outcomes 400A organized by a type of security tactic or technique, in accordance with aspects of the disclosure. A security narrative can be useful to analyze a security incident either during the security incident, or after the security incident has occurred. The graphical representation of security outcomes 400A can be a graphical representation of a portion of a security incident. The graphical representation of security outcomes 400A shows security outcomes organized by security infiltration tactics. For example, the graphical representation can be organized according to the MITRE ATT&CK® (Adversarial Tactics, Techniques, and Common Knowledge) framework, which categorizes and describes various tactics and techniques used by adversaries during cyber-attacks.

As illustrated, each labeled column (e.g., “tactics” and/or “techniques”) can include multiple security outcomes. In some embodiments, each security outcome can correspond to a respective security rule performed that was performed on input security data and/or input security outcomes (from previously performed security rules). That is, a security outcome can be obtained based from a single set of security data, or multiple sets of security data. In the illustrative FIG. 4A, the columns are labeled with initial access 410, lateral movement 420, command and control 430, exfiltration 440, and outcome 450. During an illustrative security incident, access 411 and access 412 both occurred as forms of the initial access 410. Movement 421 occurred as a form of lateral movement 420. Command 431 and command 432 occurred as forms of command and control 430. Exfiltration 441 occurred as a form of exfiltration 440. Outcome 451, outcome 452, and outcome 453 occurred as forms of outcome 450. Dashed-line elements, such as access 413 and movement 422 can be inferred or predicted tactics or techniques that have not been discovered or presented in the graphical representation of security outcomes 400A. The dashed-line elements may be predicted based on a variety of factors, including which elements are present in the graphical representation of security outcomes 400A, commonalities between elements, or known chains of security outcomes. An additional example is described below with reference to FIG. 4B.

An exemplary chain of security outcomes (e.g., based on an underlying chain of security rules) is represented in gray, and includes access 411, command 431, exfiltration 441, and outcome 452. This exemplary chain of security outcomes can correspond to a chain of security rules. That is, each outcome in the chain of outcomes can correspond to a respective security rule in a chain of security rules. Identifying chains of security rules in a security narrative (e.g., using the graphical representation of security outcomes 400A) allows organizations (e.g., client organization 102) to have a better understanding of how a security incident occurred. This can provide the organization with more granular and comprehensive feedback for how and where cybersecurity practices of the organization can be improved, or which cybersecurity practices are effective. Constructing, or identifying this chain of security narrative based on these granular security outcomes is made possible by using chains of security rules as opposed to large multi-variate rules that may produce similar output data, albeit in a less organized format.

An incomplete view of a security narrative for a security incident can leave an organization or security platform open to potential risk. However, when security outcomes can be mapped to each individual actions in a client organization's computing environment, or sets of security data, and subsequently chained together (e.g., based on a corresponding chain of security rules), additional security threats that map to the known chain of security rules are more easily discovered and represented in a security narrative. By chaining together multiple single-variate rules (that each correspond to a respective input of security data and/or security outcomes), an organization can receive a more comprehensive or granular view of the current security of their computing environment (e.g., cybersecurity protections). This is in comparison to large and often unwieldy (and slower) multi-variate rules that may be accurate, but that are unable to provide detailed indications of how certain security threats or sets of data (e.g., security data or security outcomes) actually interact to produce a certain outcome.

FIG. 4B is a graphical representation of security outcomes 400B organized by a type of security tactic or technique, in accordance with aspects of the disclosure. It can be noted that aside from the different highlighted chain of security outcomes, the graphical representation of security outcomes 400B can be the same as, or similar to the graphical representation of security outcomes 400A of FIG. 4A.

As described above, security threats to a computing environment of a client organization can occur sequentially, build on each other, and/or otherwise be connected to the same security incident. Security outcomes that are obtained from chained security rules that are performed on information that describes these security threats can similarly be linked or “chained” together. In FIG. 4B, an exemplary chain of security outcomes is represented in gray, which is different from the chain of security outcomes represented in the FIG. 4A. The exemplary chain of security outcomes in the FIG. 4B includes access 413 (which is predicted or inferred), movement 421, command 432, exfiltration 441, and outcome 452. In some embodiments, the actual security threats corresponding to solid-line elements in the FIG. 4B can occur and be detected. However, it may be possible to identify additional security threats that were not initially detected but determining if there are similarities in the detected elements to known rule/outcome chains. For example, while the observed security threats and corresponding outcomes (e.g., obtained by performing a security rule on information describing the security threat) do not include access 413, the rest of a known chain including access 413 (e.g., the elements including movement 421, command 432, exfiltration 441, and outcome 452 and outcome 453) may be actually observed or detected. By overlaying the known-chain that has a high correspondence (e.g., multiple matching elements, and/or characteristics), the presence or additional potential security threats (e.g., that correspond to outcomes generated by a respective security rule) can be predicted or inferred. An organization or security platform can then attempt to identify these “missing links” in the chain to ensure that all elements of the security incident have been accounted for. That is, due to a high degree of overlap between the chain of security outcomes represented in gray, and the known or detected security outcomes represented as solid line elements in the graphical representation of security outcomes 400B, a security platform (e.g., the security platform 120) can predict that access 413 may have occurred, with a certain degree of likelihood. This can be presented to an organization as a finding for potential investigation, as the access 413 may have initially gone undetected, and could potentially be the basis for a future security compromise.

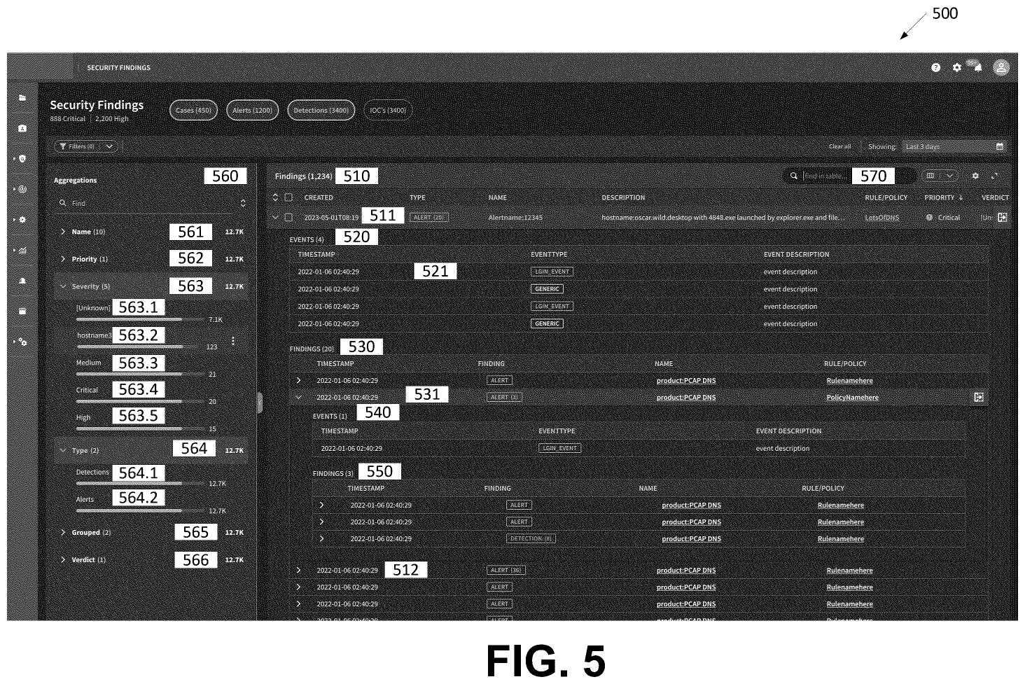

FIG. 5 illustrates an example GUI element 500 for exploring security rule chains in a security platform, in accordance with aspects of the disclosure.

The GUI element 500 includes findings 510, events 520, findings 530, events 540, findings 550, and aggregations 560.

Findings 510 is graphical element of an overall listing in a dashboard of security platform findings (e.g., security outcomes 220 as described with reference to FIG. 2) for ingested security data. Findings 510 includes a first graphical element 511 for a first specific finding and a second graphical element 512 for a second graphical element 512 for a second specific finding. As illustrated, the first graphical element 511 has been selected and expanded. In some embodiments, the first graphical element can be expanded by selecting (e.g., a single click, double click, check box selection, touch or tap, or the like) a portion of the first graphical element 511 (e.g., any location along the illustrated row for the first graphical element 511). When the first graphical element 511 is not expanded, the first graphical element 511 can resemble the second graphical element 512 in the collapsed form. In some embodiments, multiple graphical elements (e.g., first graphical element 511 and second graphical element 512) can be expanded simultaneously. In some embodiments, when the second graphical element 512 is selected to expand, the first graphical element 511 can be collapsed (e.g., to resemble the illustrative second graphical element 512).

When expanded, the first graphical element 511 includes events 520, and event findings 530 that contain information for the events 520. In some embodiments, selecting a graphical element of one of the events 520 can highlight or expand the corresponding event findings. For example, selecting the graphical element 521 of the events 520 can expand the graphical element 531 of event findings 530. In some embodiments, the graphical element 531 of event findings 530 can be expanded by selecting the graphical element 531 (e.g., single click, double click, check box selection, touch or tap, or the like). The expanded graphical element 531 can include events 540 and event findings 550. It can be appreciated that these graphical elements (e.g., events and event findings) can be explored through a full rule chain.

For example, for a rule chain having four rules chained together sequentially, findings 510 can related to the final rule (e.g., rule four). The graphical element 511 can be expanded, which corresponds to the previous rule (e.g., rule three) and includes corresponding events (e.g., events 520) and findings (e.g., event findings 530). The graphical element 531 of event findings 530 (e.g., for rule three in the chain of four rules) can be expanded to include events (e.g., events 540) and findings (e.g., event findings 550) for the rule previous to rule three (e.g., rule two). These cascading drop-down style menus can be continually expanded until reaching the first rule. It can be appreciated that in some embodiments, the exploration of rule chains in this manner can be from in reverse. That is, as described in the example above, the first graphical elements presented in the GUI (in unexpanded forms) are for a last rule in a chain of rules, and that expanding graphical elements (e.g., graphical element 511, graphical element 512, etc.) for additional rules from this perspective will correspond to previously performed rules in the chain of rules.

As illustrated, graphical elements for findings (e.g., findings 510, event findings 530, event findings 550, etc.) can include various categories of information, including a timestamp, a type or label, a name, a description, a security rule identifier or policy identifier, a priority, and a verdict. Similarly, as illustrated, graphical elements for events (e.g., events 520, events 540, etc.) can include various categories of information, including the event type, and event description.

In some embodiments, the graphical element for aggregations 560 can include an overall view for all findings displayed in findings 510. In some embodiments, when a finding is selected (e.g., the first graphical element 511 for a first finding), the graphical element for aggregations 560 can display an overall view corresponding to the selected finding.

The graphical element for aggregations 560 can include filters based on categories of information displayed for findings and/or events. Illustratively, these filters include name 561, priority 562, severity 563, type 564, grouped rule or policy 565, and verdict 566. Each of these categories can be expanded, indicated by the sideways carrot in the graphical element next to the graphical element textual label. Illustratively, severity 563 has been expanded, and illustratively includes selections for unknown 563.1, hostname3 563.2, medium 563.3, critical 563.4, and high 563.5. Similarly type 564 has been illustratively expanded and includes detections 564.1 and alerts 564.2. In some embodiments, the status bar beneath the textual label in each graphical element (e.g., the graphical element corresponding to detections 564.1) can indicate a quantity of detections 564.1 out of a total quantity of types 564. It can be appreciated that these sub-filters for the filter of severity 563 and the filter of type 564 are merely illustrative, and that other names or types of sub-filters can be similarly presented as graphical elements in the GUI element 500.

As illustrated and described herein, the GUI element 500 can allow a user to visually navigate a chain of rules, while providing information related to the chain of rules in drop-down or expanded menus. These cascading menus can facilitate the review of findings and events related to each rule in the chain of rules for a user. It can be appreciated that common table functions can apply to the tables depicted in the GUI element 500, including sort functions, filter functions, search functions (e.g., as illustrated with search 570) and the like.

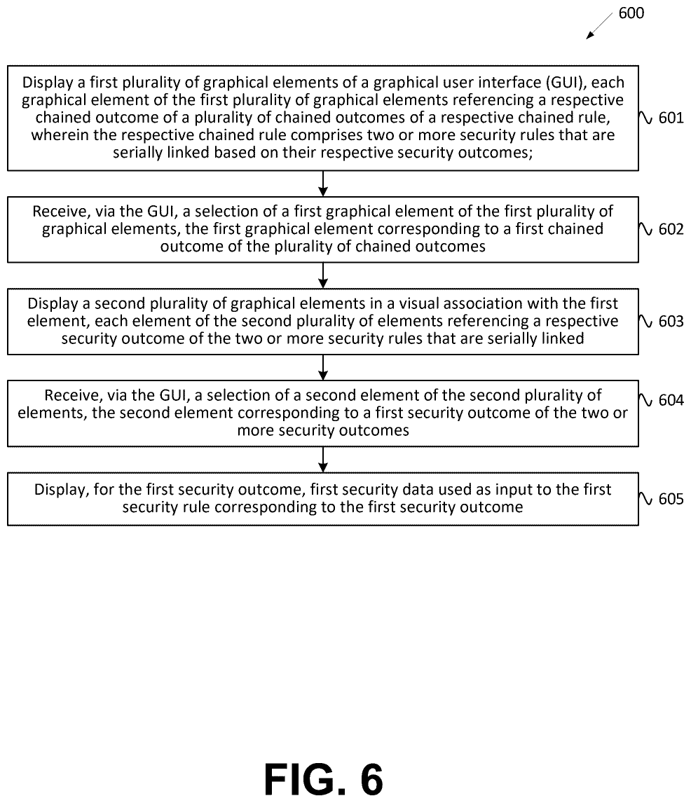

FIG. 6 illustrates an example method 600 for security rule chaining in a security platform, in accordance with aspects of the disclosure. Method 600 can be performed by processing logic that can include hardware (circuitry, dedicated logic, etc.), software (e.g., instructions run on a processing device), or a combination thereof. In one implementation, some, or all of the operations of method 600 can be performed by one or more components of system 100 of FIG. 1. In some implementations, some, or all of the operations of method 600 can be performed by the engine 141 as described above.

At operation 601, the processing logic performing the method 600 displays multiple first graphical elements of a graphical user interface (GUI). In some embodiments, each graphical element references a respective chained outcome among multiple chained outcomes of a respective chained rule. The respective chained rule can include two or more security rules that are linked based on respective security outcomes.

At operation 602, the processing logic receives, via the GUI, a selection of a first graphical element from among the multiple first graphical elements. The first graphical element can correspond to a first chained outcome of the multiple chained outcomes. In some embodiments, the first graphical element corresponding to the first security outcome is displayed in a timeline view. In some embodiments, the length of the first graphical element can correspond to a duration of time for security data that was processed to obtain the first security outcome. For example, a first security outcome including first security data with a timestamp at 0:00, and second security data with a timestamp at 0:15 can be represented as a longer graphical element than a second security outcome including first security data with a timestamp at 0:00 and second security data with a timestamp at 0:02. In some embodiments, the first graphical element can be displayed as a collapsed icon, with no, or minimal textual information. In some embodiments, the first graphical element can be displayed as an expanded graphical element with supporting textual information.

At operation 603, the processing logic displays multiple second graphical elements in a visual association with the first element. In some embodiments, each graphical element of the references a respective security outcome of the two or more security rules that are linked.

In some embodiments, linking two or more security rules based on respective security outcomes can include identifying, by the processing logic based on a predefined criterion, a first metadata item pertaining to a first security outcome of a first security rule, and a second metadata item pertaining to a second security outcome of a second security rule. The processing logic can further determine, based on the first metadata item and the second metadata item, a first link between the first security rule and the second security rule. The processing logic can further display the first security rule, the second security rule and the first link between the first security rule and the second security rule in the GUI. In some embodiments, the metadata item can include temporal data such as a timestamp, or parameters for a computer environment, such as a host name, user identifier, or the like. In some embodiments, a third security rule can similarly be displayed by identifying a third metadata item, determining a second link between the first security rule and the third security rule based on the third metadata item and the first metadata item, and displaying the first security rule, the third security rule and the second link between the first security rule and the third security rule in the GUI.

At operation 604, the processing logic receives, via the GUI, a selection of a second element from among the multiple second graphical elements, the second graphical element corresponding to a first security outcome of the two or more security outcomes.

At operation 605, the processing logic displays, for the first security outcome, first security data used as input to the first security rule corresponding to the first security outcome.

In some embodiments, the processing logic can display a secondary graphical element corresponding to the first graphical element in the GUI. The secondary graphical element can be displayed in a security response framework. For example, the secondary graphical element can be displayed in a graphical representation of the MITRE ATT&CK® security framework.

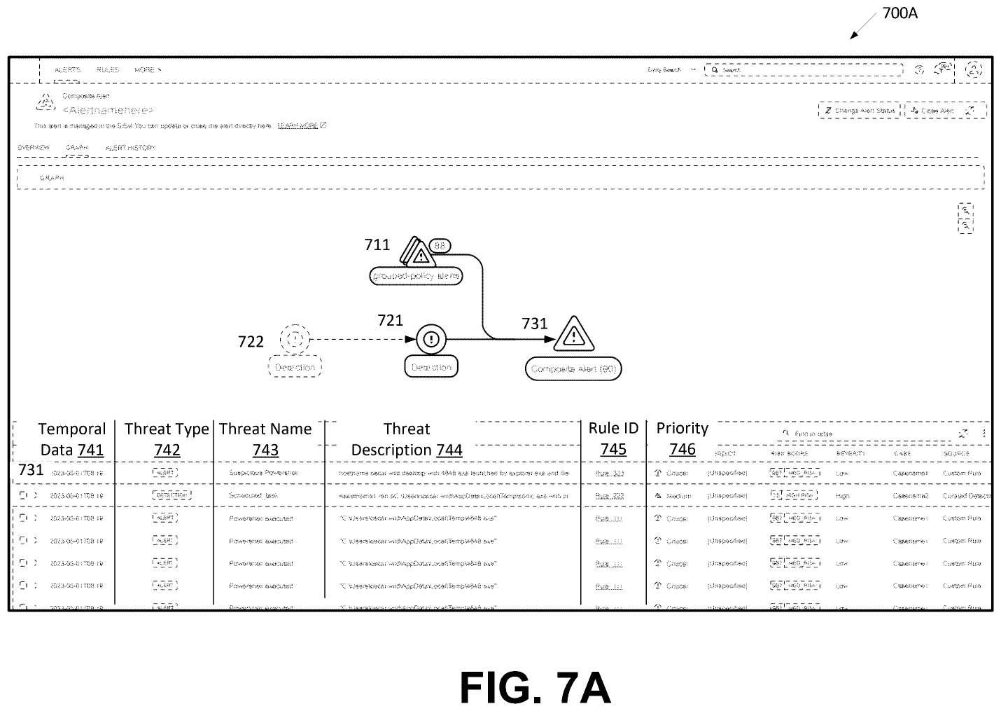

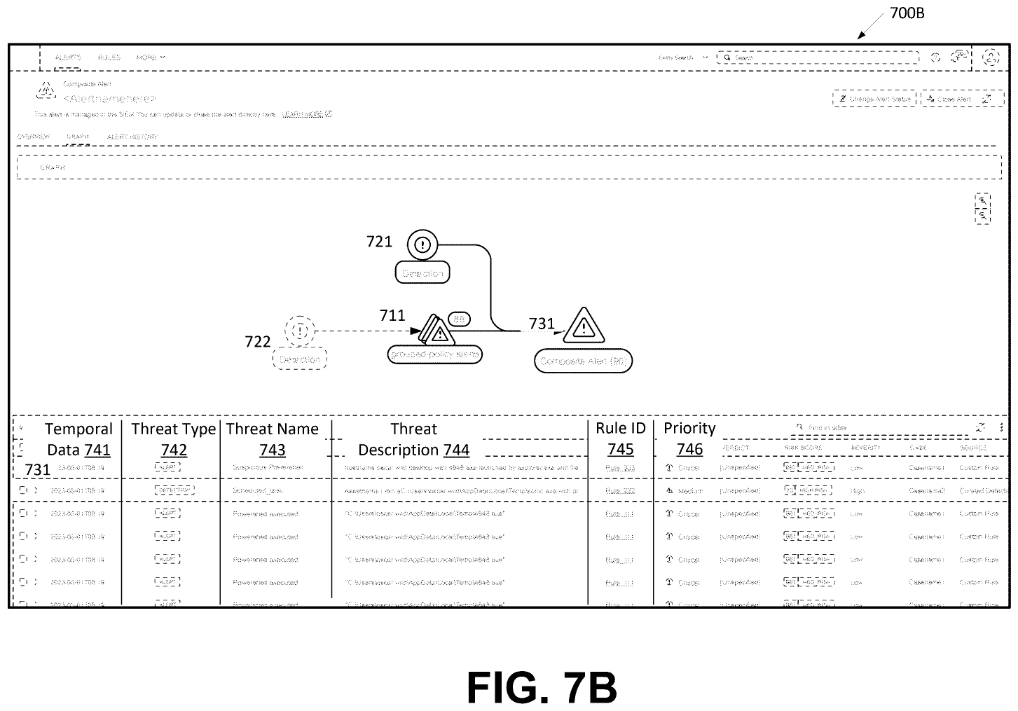

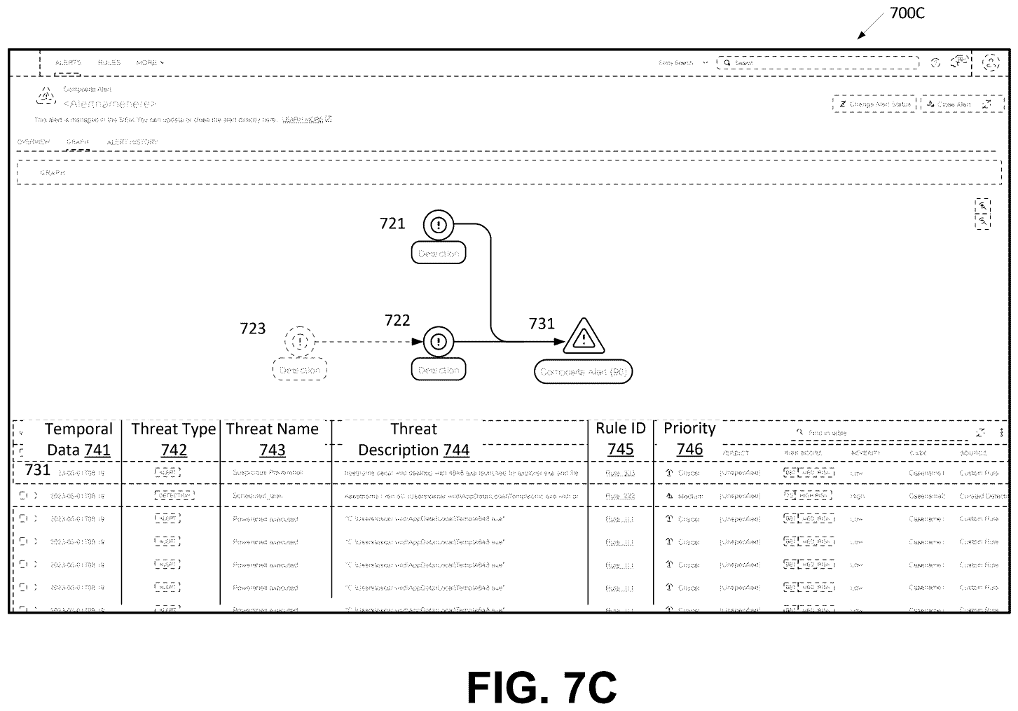

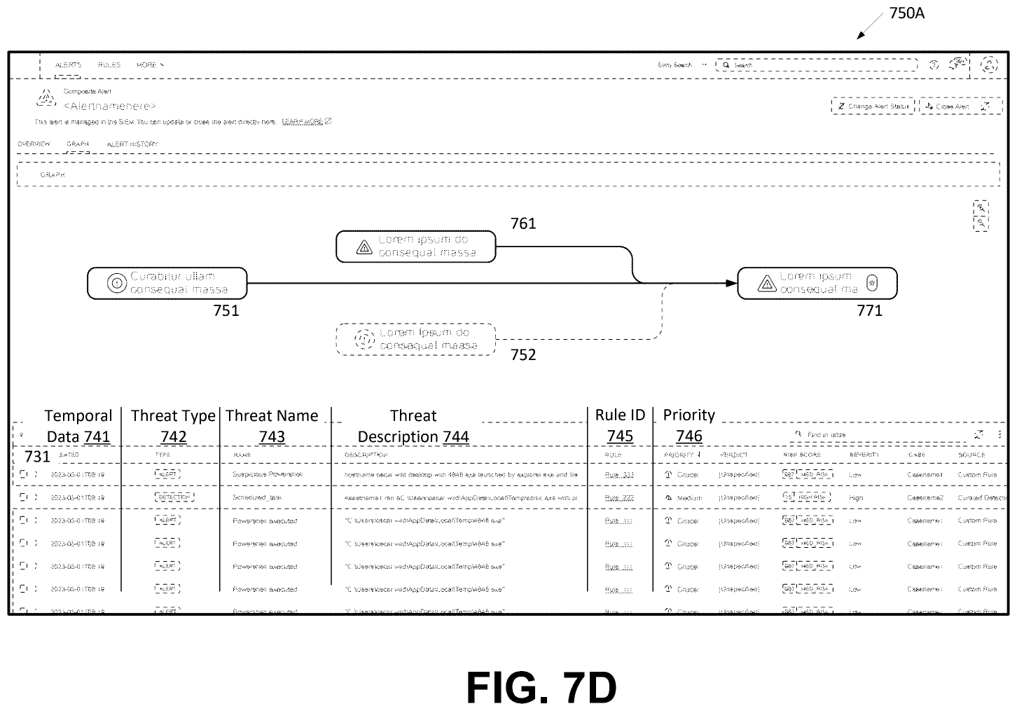

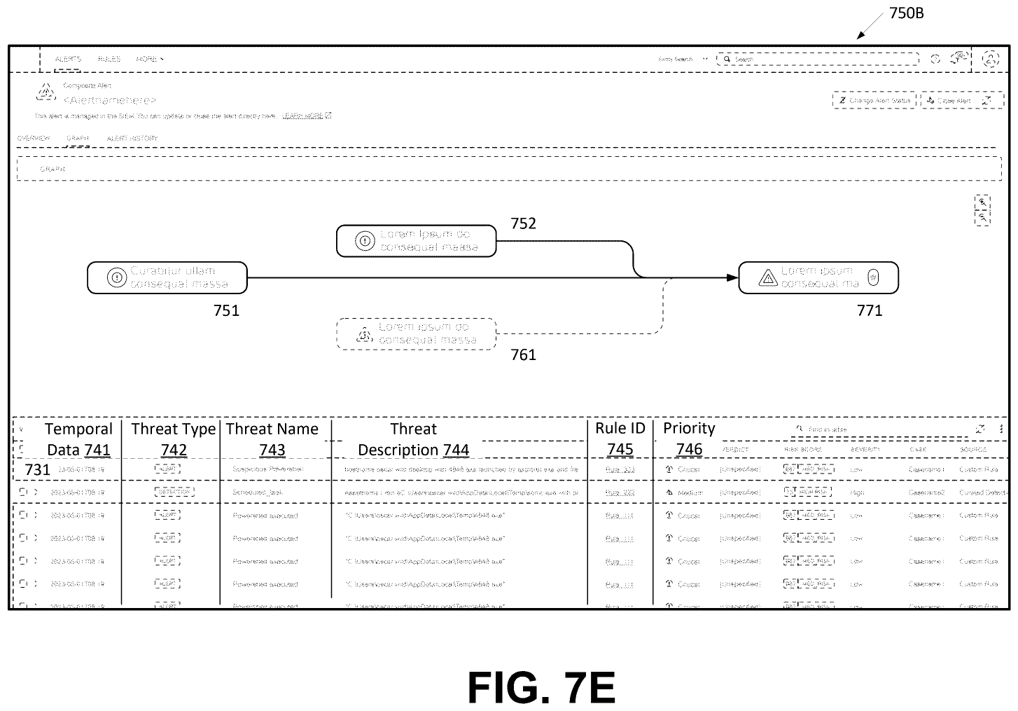

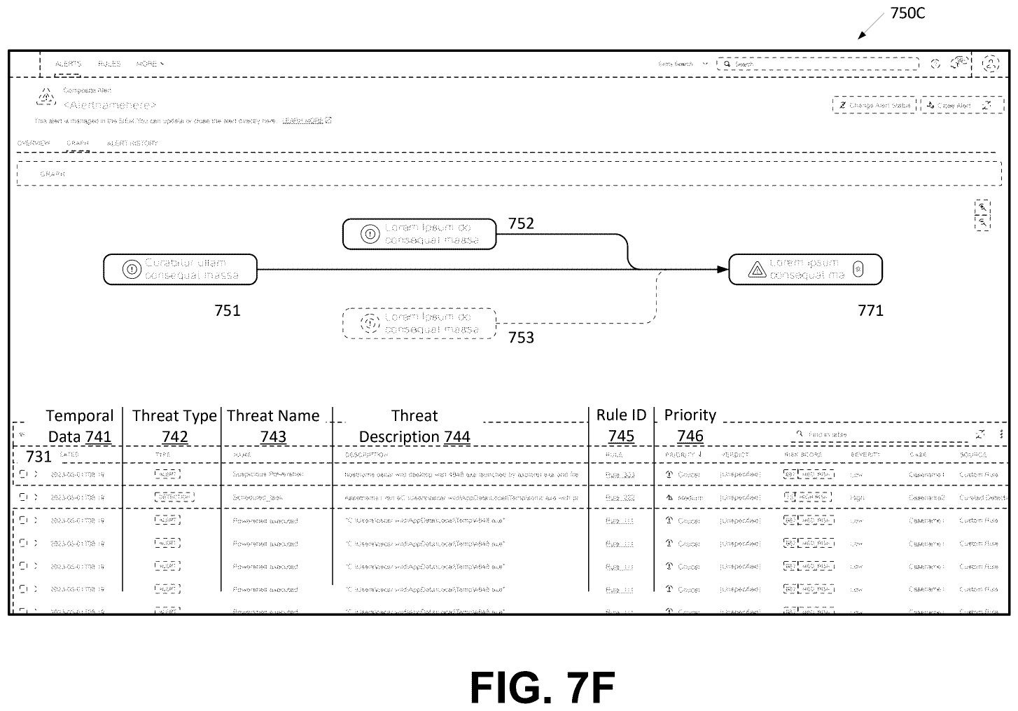

FIG. 7A is an example GUI 700A for exploring security rule chains in a security platform, in accordance with aspects of the disclosure. GUI 700A illustrates a collapsed icon view of a security rule chain.

GUI 700A includes alert 711, detection 721, detection 722, and alert 731. In some embodiments, alert 711 can be a grouping of multiple alerts (e.g., grouped policy alerts). In some embodiments, alert 731 can be a composite alert that includes information describing the alert(s) 711, detection(s) 721, and/or detection(s) 722. Detection 722 is illustrated in dashed lines as an optional visual representation of a previous rule in a rule chain.

The GUI 700A can be constructed based on a defined chain of rules, such as described in FIG. 3A and FIG. 3B. In some embodiments, the GUI 700A is automatically constructed and displayed based on characteristics or metadata associated with rules in a chain of rules. The alert 731 can be a final alert for the chain of rules, which can be selected from table of security outcomes, as illustrated. In some embodiments, the alert 731 reflects a final security outcome (e.g., an alert, a detection, an event, or other security outcome 220 as described in FIG. 2, etc.). The table of security outcomes can display information about each security outcome including one of more of an indicator of the security outcome (e.g., alert 731), temporal data 741 (e.g., a timestamp), a threat type 742, a threat name 743, a threat description 744, a security rule identifier 745, a priority 746, or the like. It can be appreciated that while these specific columns are illustrated and described, additional columns and data or metadata for a security outcome (e.g., alert 731) can be similarly displayed in the table of security outcomes.

FIG. 7B is an example GUI 700B for exploring security rule chains in a security platform, in accordance with aspects of the disclosure. GUI 700B illustrates a collapsed icon view of a security rule chain. GUI 700B includes alert 711, detection 721, detection 722, and alert 731. In some embodiments, alert 711 can be a grouping of multiple alerts (e.g., grouped policy alerts). In some embodiments, alert 731 can be a composite alert that includes information describing the alert(s) 711, detection(s) 721, and/or detection(s) 722. The GUI 700B can include the same or features of GUI 700A as described with reference to FIG. 7A.

FIG. 7C is an example GUI 700C for exploring security rule chains in a security platform, in accordance with aspects of the disclosure. GUI 700C illustrates a collapsed icon view of a security rule chain. GUI 700C includes, detection 721, detection 722, detection 723 and alert 731. In some embodiments, alert 731 can be a composite alert that includes information describing detection(s) 721, detection(s) 722, and/or detection(s) 723. The GUI 700C can include the same or similar features of GUI 700A as described with reference to FIG. 7A.

FIG. 7D is an example GUI 750A for exploring security rule chains in a security platform, in accordance with aspects of the disclosure. GUI 750A illustrates an expanded view of a security rule chain. Detection 752 is illustrated in dashed lines as an optional visual representation of a previous rule in a rule chain.

GUI 750A includes alert 761, detection 751, detection 752, and alert 771. In some embodiments, alert 761 can be a grouping of multiple alerts (e.g., grouped policy alerts). In some embodiments, alert 771 can be a composite alert that includes information describing the alert(s) 761, detection(s) 751, and/or detection(s) 752. The GUI 750A can include the same or similar features of GUI 750A as described with reference to FIG. 7D.

FIG. 7E is an example GUI 750B for exploring security rule chains in a security platform, in accordance with aspects of the disclosure. GUI 750B illustrates an expanded view of a security rule chain. Alert 761 is illustrated in dashed lines as an optional visual representation of a previous rule in a rule chain.

GUI 750A includes alert 761, detection 751, detection 752, and alert 771. In some embodiments, alert 761 can be a grouping of multiple alerts (e.g., grouped policy alerts). In some embodiments, alert 771 can be a composite alert that includes information describing the alert(s) 761, detection(s) 751, and/or detection(s) 752. The GUI 750B can include the same or similar features of GUI 750A as described with reference to FIG. 7D.

FIG. 7F is an example GUI 750C for exploring security rule chains in a security platform, in accordance with aspects of the disclosure. GUI 750C illustrates an expanded view of a security rule chain. GUI 750A detection 751, detection 752, detection 753, and alert 771. In some embodiments, alert 771 can be a composite alert that includes information describing the detection(s) 751, and/or detection(s) 752, and/or detection(s) 753. The GUI 750C can include the same or similar features of GUI 750A as described with reference to FIG. 7D.

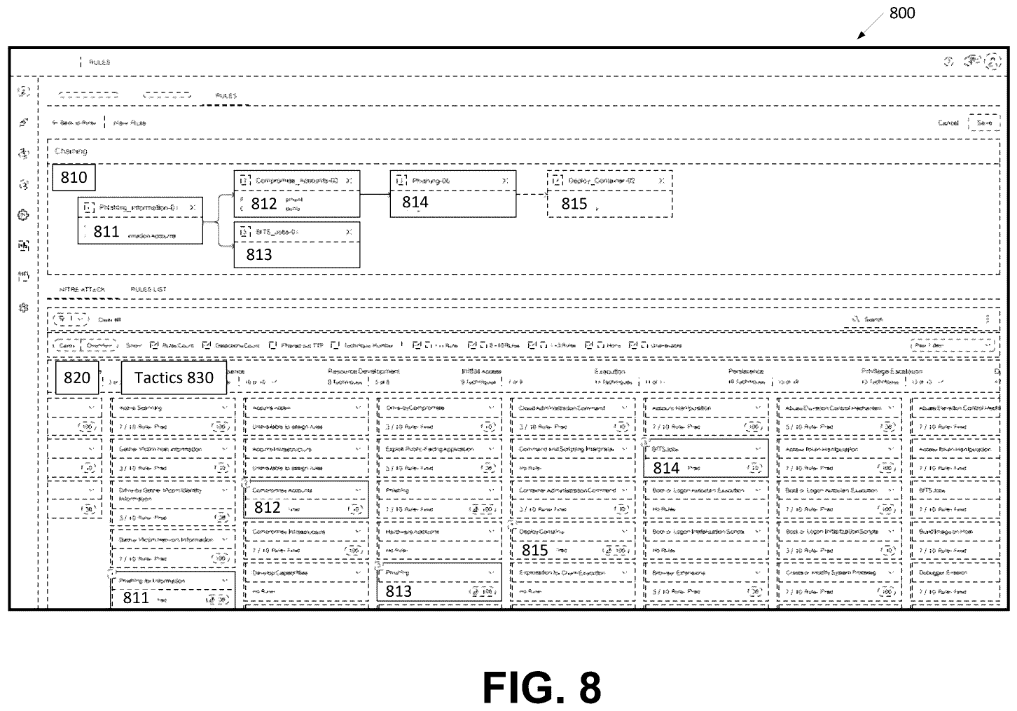

FIG. 8 is an example GUI 800 for exploring security rule chains in a security platform, in accordance with aspects of the disclosure. The GUI 800 illustrates a visual view of a chain of security outcomes 810, including security outcome 811, security outcome 812, security outcome 813, security outcome 814, and security outcome 815.

The GUI 800 also illustrates a visual view of a security framework 820, which visually maps security outcomes into known tactics or techniques. In some embodiments, the visual view of the security framework 820 can be a visual view of the MITRE ATT&CK security framework. As illustrated, the elements in the chain of security outcomes 810 are mapped into corresponding tactics or techniques 830.

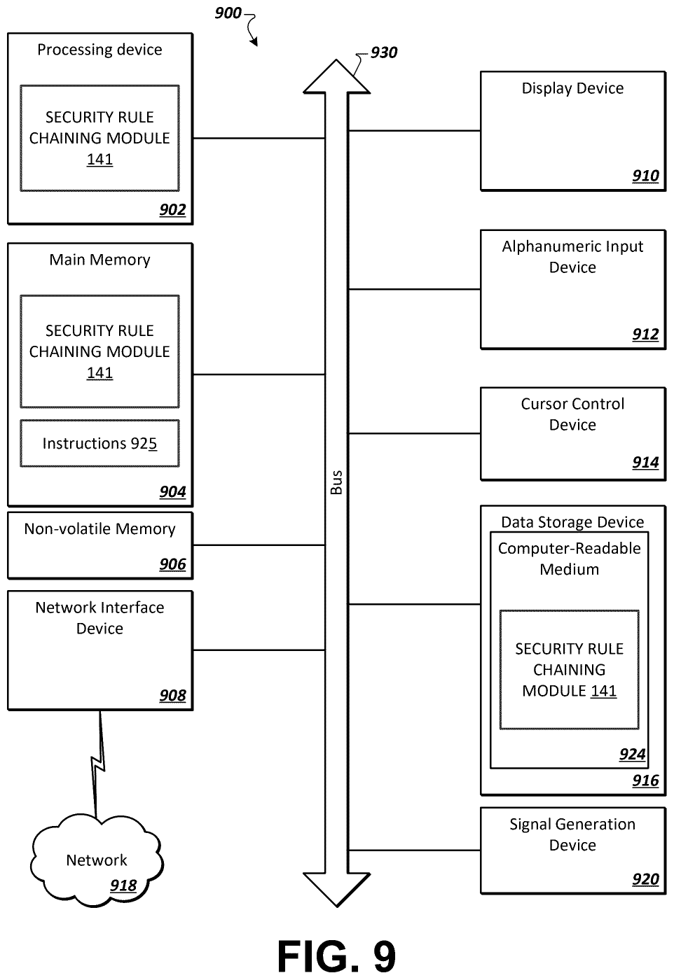

FIG. 9 is a block diagram illustrating an example of a computer system 900, according to aspects of the disclosure. The computer system 900 can correspond to security platform 120 and/or client devices 102A-N, described in FIG. 1. Computer system 900 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 900 includes a processing device 902 (e.g., a processor), a main memory 904 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 906 (e.g., flash memory, static random access memory (SRAM), etc.), and a data storage device 916, which communicate with each other via a bus 930. In some embodiments, the main memory 904 can be a non-transitory computer readable storage medium.

Processing device 902 represents one or more general-purpose processing devices such as a microprocessor, central processing unit, or the like. More specifically, processing device 902 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 can also be one or more special-purpose processing devices such as an application specific integrated circuit (ASIC), a field programmable gate array (FPGA), a digital signal processor (DSP), network processor, or the like. The processing device 902 is configured to execute network interface device 908 (e.g., for synchronizing data between platforms) for performing the operations discussed herein. The processing device 902 can be configured to execute instructions 925 stored in main memory 904. Non-volatile memory 906 can store the instructions 925 when they are not being executed, and can store additional system data that can be accessed by processing device 902.

The computer system 900 can further include a network interface device 908. The computer system 900 also can include a video display unit 910 (e.g., a liquid crystal display (LCD) or a cathode ray tube (CRT)), an input device 912 (e.g., a keyboard, and alphanumeric keyboard, a motion sensing input device, touch screen), a cursor control device 914 (e.g., a mouse), and a signal generation device 918 (e.g., a speaker).

The data storage device 916 can include a computer-readable storage medium 924 (e.g., a non-transitory machine-readable storage medium) on which is stored one or more sets of instructions 925 (e.g., for generating variations of a translated audio portion) embodying any one or more of the methodologies or functions described herein. The instructions can also reside, completely or at least partially, within the main memory 904 and/or within the processing device 902 during execution thereof by the computer system 900, the main memory 904 and the processing device 902 also constituting machine-readable storage media. The instructions can further be transmitted or received over a network 920 via the network interface device 908.

While the computer-readable storage medium 924 (machine-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a specific feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
displaying a first plurality of graphical elements of a graphical user interface (GUI), each graphical element of the first plurality of graphical elements referencing a respective chained outcome of a plurality of chained outcomes of a respective chained rule, wherein the respective chained rule comprises two or more security rules that are linked based on their respective security outcomes;
receiving, via the GUI, a selection of a first graphical element of the first plurality of graphical elements, the first graphical element corresponding to a first chained outcome of the plurality of chained outcomes; and
displaying a second plurality of graphical elements in a visual association with the first graphical element, each element of the second plurality of graphical elements referencing a respective security outcome of the two or more security rules that are serially linked.

2. The method of claim 1, further comprising:
receiving, via the GUI, a selection of a second graphical element of the second plurality of graphical elements, the second element corresponding to a first security outcome of the two or more security outcomes; and
displaying, for the first security outcome, first security data used as input to a first security rule corresponding to the first security outcome.

3. The method of claim 1, wherein the first graphical element corresponding to the first chained outcome is displayed in a timeline view.

4. The method of claim 3, wherein a second graphical element corresponding to a second chained outcome is displayed in the timeline view in a sequence with the first graphical element.

5. The method of claim 4, wherein the sequence is determined by the plurality of chained outcomes.

6. The method of claim 1, wherein linking the two or more security rules based on their respective security outcomes further comprises:
identifying, based on a predefined criterion, a first metadata item pertaining to a first security outcome of a first security rule of the two or more security rules;
identifying, based on the predefined criterion, a second metadata item pertaining to a second security outcome of a second security rule of the two or more security rules;
determining, based on the first metadata item and the second metadata item, a first link between the first security rule and the second security rule; and
displaying the first security rule, the second security rule, and the first link between the first security rule and the second security rule in the GUI.

7. The method of claim 6, wherein the first metadata item comprises one or more first timestamps, and wherein the second metadata item comprises one or more second timestamps.

8. The method of claim 6, further comprising:
identifying, based on the predefined criterion, a third metadata item pertaining to a third security outcome of a third security rule of the two or more security rules;
determining, based on the third metadata item and the first metadata item, a second link between the first security rule and the third security rule; and
displaying the first security rule, the third security rule, and the second link between the first security rule and the third security rule in the GUI.

9. The method of claim 1, further comprising:
displaying a secondary graphical element corresponding to the first graphical element in the GUI, wherein the secondary graphical element is displayed in a security response framework.

10. A system comprising:
a memory; and
one or more processing devices coupled with the memory, the one or more processing devices to perform operations comprising:
displaying a first plurality of graphical elements of a graphical user interface (GUI), each graphical element of the first plurality of graphical elements referencing a respective chained outcome of a plurality of chained outcomes of a respective chained rule, wherein the respective chained rule comprises two or more security rules that are linked based on their respective security outcomes;
receiving, via the GUI, a selection of a first graphical element of the first plurality of graphical elements, the first graphical element corresponding to a first chained outcome of the plurality of chained outcomes; and
displaying a second plurality of graphical elements in a visual association with the first element, each element of the second plurality of elements referencing a respective security outcome of the two or more security rules that are serially linked.

11. The system of claim 10, the operations further comprising:
receiving, via the GUI, a selection of a second element of the second plurality of elements, the second element corresponding to a first security outcome of the two or more security outcomes; and
displaying, for the first security outcome, first security data used as input to a first security rule corresponding to the first security outcome.

12. The system of claim 10, wherein the first graphical element corresponding to the first chained outcome is displayed in a timeline view.

13. The system of claim 12, wherein a second graphical element corresponding to a second chained outcome is displayed in the timeline view in a sequence with the first graphical element.

14. The system of claim 13, wherein the sequence is determined by the plurality of chained outcomes.

15. The system of claim 10, wherein linking the two or more security rules based on their respective security outcomes further comprises:
identifying, based on a predefined criterion, a first metadata item pertaining to a first security outcome of a first security rule of the two or more security rules;
identifying, based on the predefined criterion, a second metadata item pertaining to a second security outcome of a second security rule of the two or more security rules;
determining, based on the first metadata item and the second metadata item, a first link between the first security rule and the second security rule; and
displaying the first security rule, the second security rule, and the first link between the first security rule and the second security rule in the GUI.

16. The system of claim 15, wherein the first metadata item comprises one or more first timestamps, and wherein the second metadata item comprises one or more second timestamps.

17. The system of claim 15, the operations further comprising:
identifying, based on the predefined criterion, a third metadata item pertaining to a third security outcome of a third security rule of the two or more security rules;
determining, based on the third metadata item and the first metadata item, a second link between the first security rule and the third security rule; and
displaying the first security rule, the third security rule, and the second link between the first security rule and the third security rule in the GUI.

18. The system of claim 10, the operations further comprising:
displaying a secondary graphical element corresponding to the first graphical element in the GUI, wherein the secondary graphical element is displayed in a security response framework.

19. A non-transitory computer readable storage medium comprising instructions for a server that, when executed by a processing device, cause the processing device to perform operations comprising:
displaying a first plurality of graphical elements of a graphical user interface (GUI), each graphical element of the first plurality of graphical elements referencing a respective chained outcome of a plurality of chained outcomes of a respective chained rule, wherein the respective chained rule comprises two or more security rules that are linked based on their respective security outcomes;
receiving, via the GUI, a selection of a first graphical element of the first plurality of graphical elements, the first graphical element corresponding to a first chained outcome of the plurality of chained outcomes; and
displaying a second plurality of graphical elements in a visual association with the first element, each element of the second plurality of elements referencing a respective security outcome of the two or more security rules that are serially linked.

20. The non-transitory computer readable storage medium of claim 19, the operations further comprising:
receiving, via the GUI, a selection of a second element of the second plurality of elements, the second element corresponding to a first security outcome of the two or more security outcomes; and
displaying, for the first security outcome, first security data used as input to a first security rule corresponding to the first security outcome.
